(19) United States
(12) Patent Application Publication
(10) Pub. No.: US 2017/0016402 A1
(43) Pub. Date: Jan. 19, 2017

(54) APPARATUS AND METHOD FOR CONTROLLING INTAKE SURGE NOISE OF ENGINE OF VEHICLE

(71) Applicants: Kia Motors Corporation, Seoul (KR); Hyundai Motor Company, Seoul (KR)

(72) Inventors: Jae Sung Myung, Yongin (KR); Seung Ho Choi, Uiwang (KR)

(21) Appl. No.: 14/966,457

(22) Filed: Dec. 11, 2015

(30) Foreign Application Priority Data
Jul. 13, 2015 (KR) 10-2015-0098834

(51) Int. Cl. F02D 9/02; F02M 35/10; F02D 41/12; F02D 11/10

(52) U.S. Cl. CPC F02D 9/02; F02D 11/105; F02M 35/1038; F02D 41/123; F02D 2200/101; F02D 2200/501; F02D 2009/0228; F02D 2009/023

(57) ABSTRACT

An apparatus and a method for controlling intake surge noise of an engine of a vehicle are provided to suppress generation of noise due to an intake surge using an opening/closing location of a throttle valve and a time control when an intake surge pressure is generated. In particular, surge pressure and surge noise are removed by excluding an existing anti-surge valve or an existing intake purge valve, and determining whether intake surge generation conditions including a fuel supply state, intake pressures at front and rear ends of a throttle valve, a vehicle speed, and an engine speed to control an opening degree of the throttle valve for a predetermined time period.

### CROSS-REFERENCE TO RELATED APPLICATION

This application claims under 35 U.S.C. §119(a) the benefit of Korean Patent Application No. 10-2015-0098834 filed on Jul. 13, 2015, which is incorporated by reference herein in its entirety.

### BACKGROUND

(a) Technical Field

The present invention relates to an apparatus and a method for controlling intake surge noise of a vehicle engine, and more particularly, to an apparatus and a method for controlling intake surge noise of a vehicle engine, by which generation of noise due to an intake surge are suppressed using an opening/closing location of a throttle valve and a time control when an intake surge pressure is generated.

(b) Description of the Related Art

In general, a turbocharger system of a vehicle is adapted to retrieve kinetic energy of exhaust gas discharged from an engine of a vehicle and to supercharge air supplied into the engine. Additionally, the turbocharger system includes a turbocharger turbine mounted on an exhaustion side of the engine, and a compressor coaxially connected to the turbocharger turbine, for supercharging intake air into the engine.

### SUMMARY

The present invention provides an apparatus and a method for controlling intake surge noise of an engine of a vehicle, by which surge pressure and surge noise may be removed by excluding an existing anti-surge valve or an existing intake purge valve, and determining whether intake surge generation conditions including a fuel supply state, intake pressures at front and rear ends of a throttle valve, a vehicle speed, and an engine speed to adjust an opening degree of the throttle valve for a predetermined time period.

In accordance with an aspect of the present invention, an apparatus for controlling intake surge noise of an engine of a vehicle may include: an accelerator pedal pushing degree detection sensor configured to detect an engagement degree (e.g., the amount of pressure exerted onto a pedal) associated with a closed state of a throttle valve, while the vehicle is accelerated; a first pressure sensor configured to detect an intake pressure at a front end of the throttle valve; a speed sensor configured to detect a current vehicle speed; an engine revolutions per minute (RPM) sensor configured to detect a current engine speed; and a controller configured to interrupt supply of a fuel into an engine and open the throttle valve at a predetermined degree for a predetermined time period simultaneously, when the throttle valve is closed. A detection value of the first pressure sensor may be a threshold pressure or greater and the vehicle speed and the engine speed may be threshold values or greater. The apparatus may further include: a second pressure sensor configured to detect an intake pressure in an intake manifold at a rear end of the throttle valve.

In accordance with another aspect of the present invention, a method for controlling intake surge noise of an engine of a vehicle may include: detecting a closed state of a throttle valve while the vehicle is accelerated; detecting an intake pressure in an intake manifold at a front end of the throttle valve; detecting a current vehicle speed and an engine speed; and interrupting a supply of a fuel into an engine and opening the throttle valve at a predetermined degree for a predetermined time period simultaneously. When the throttle valve is closed, the intake pressure in the intake manifold at the front end of the throttle valve may be a threshold pressure or greater and the vehicle speed and the engine speed may be threshold values or greater.

The method may further include: detecting an intake pressure in an intake manifold at a rear end of the throttle valve and closing the throttle valve after the throttle valve is opened at a predetermined opening degree for a predetermined time period. The threshold pressure may be a threshold value for an intake pressure that generates surge noise and influences the durability of the compressor while the throttle valve is closed, and may be a value measured using an actual vehicle driving test. The threshold speed may be a value measured using an actual vehicle driving test, considering that surge noise is generated at a predetermined vehicle speed and a predetermined engine speed.

The present invention provides the following effects through the apparatus and method.

First, surge pressure and surge noise may be removed more easily by opening a throttle valve for a predetermined time period in surge generation conditions, based on data such as a fuel supply state, intake pressures in an intake manifold at front and rear ends of the throttle valve, a vehicle speed, and an engine speed.

Second, the structure of an intake system of an engine may be simplified, the number of components may be reduced, and manufacturing costs may be reduced by excluding an anti-surge valve or an intake purge valve mounted on a purge line, including an existing purge line.

### BRIEF DESCRIPTION OF THE DRAWINGS

The above and other features of the present invention will now be described in detail with reference to exemplary embodiments thereof illustrated by the accompanying drawings which are given herein below by way of illustration only, and thus are not limitative of the present invention, and wherein:

FIG. 1 is a schematic view illustrating a configuration of an engine intake/exhaust system including a turbo charger system according to the related art;

FIG. 2 is a diagram illustrating an apparatus for controlling intake surge noise of an engine of a vehicle according to an exemplary embodiment of the present invention;

FIG. 3 is a flowchart illustrating a method for controlling intake surge noise of an engine of a vehicle according to an exemplary embodiment of the present invention;

FIG. 4 is a graph illustrating a process of opening and closing a throttle valve to control intake surge noise of an engine of a vehicle according to an exemplary embodiment of the present invention; and

FIG. 5 is a graph illustrating a time point when surge noise of an engine including a turbo charger system is generated according to an exemplary embodiment of the present invention.

It should be understood that the appended drawings are not necessarily to scale, presenting a somewhat simplified representation of various features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION OF THE INVENTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like.

Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example with hin 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings.

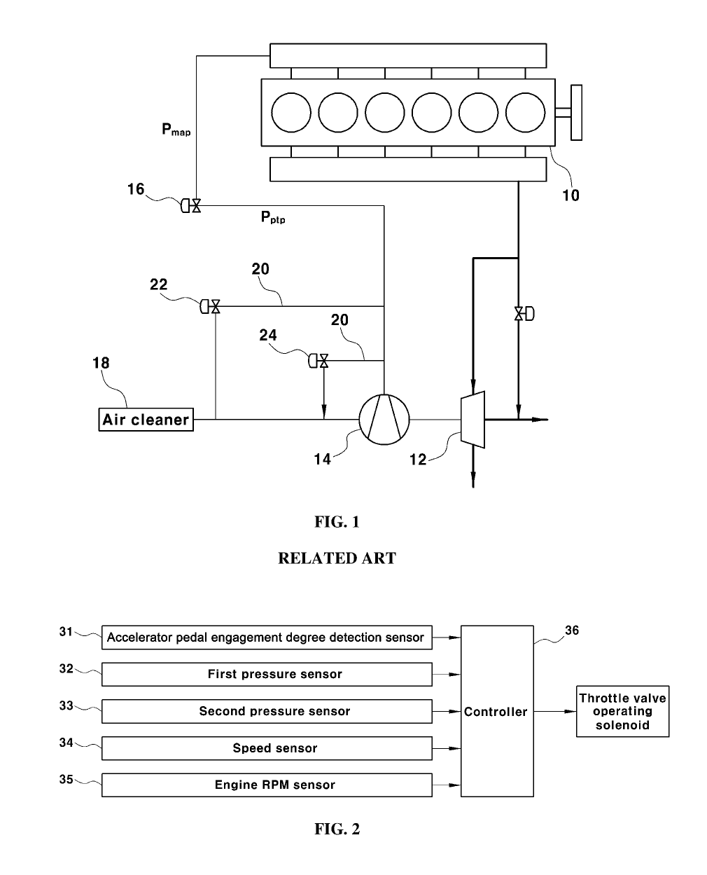

FIG. 1 is a schematic view illustrating a configuration of an engine intake/exhaust system including a turbo charger system according to the related art. A turbocharger turbine 12 is connected to an exhaust manifold of an engine 10, and a compressor 14 coaxially connected to the turbocharger turbine 12 is mounted at a front end of a throttle valve in an intake manifold of the engine. The turbocharger turbine 12 is rotated and the compressor 14 is driven simultaneously by a pressure of exhaust gas discharged from the exhaust manifold of the engine, and intake air is supercharged into a combustion chamber of the engine by driving the compressor 14, and a substantial amount of air is supplied into the combustion chamber of the engine by the supercharging and intake efficiency may increase, resulting in improvement of an output of the engine.

Meanwhile, an amount of mixed air supplied into the combustion chamber of the engine is adjusted while the throttle valve is opened and closed based on a driver request (e.g., an accelerator pedal engagement degree) to adjust an output of the engine. When the accelerator pedal is released (e.g., disengaged) after the engine is accelerated as the accelerator pedal is pushed (e.g., as pressure is exerted onto the pedal), the throttle valve is abruptly closed at a section in which the engine output is decreased to interrupt supply of air into the engine.

Accordingly, when the throttle valve is abruptly closed, the intake air in the intake manifold (e.g., at a front end of the throttle valve) is configured to generate a surge state while rapidly increasing a pressure at an exit of the compressor of the turbocharger system, and generate noise while forming pulse waves and applying an impact to the compressor via an intercooler simultaneously. In addition, when the turbocharger system faces a surge state, noise is generated by an imbalance of pressure and a secondary problem such as abrasion of a bearing included in the compressor may occur. Accordingly, the intake surge pressure causing the above-mentioned problem may be removed according to an exemplary embodiment of the present invention.

Particularly, to reduce surge noise by removing an intake surge pressure according to the related art, a method has been developed of connecting an intake line between a front end of a throttle valve 16 and an exit of a compressor 12 and an intake line between an air cleaner into which air is initially introduced and an entrance of the compressor 12 using a bypass line 20, and mounting an anti-surge valve 22 on the bypass line 20 to bypass the pressure of intake air that generates surge noise into a front end of the compressor 12 to remove the pressure of the intake air, as illustrated in FIG. 1.

Alternatively, a method of bypassing residual intake air to a front end of a compressor by mounting a separate intake purge valve 24 for adjusting an amount of intake air on the bypass line 20 is used. However, the method of reducing intake surge noise according to the related art has the following problems. First, when the intake air is bypassed from a portion (e.g., an exit of the compressor) where an intake air pressure is high to a portion (e.g., a front end of the compressor) where the intake air pressure is low, discharge noise of the air is generated by a pressure difference between the parts. Second, for example, since a bypass line is built to remove intake surge pressure and an anti-surge valve or an intake purge valve is mounted on the bypass line, the structure of an intake system of an engine is complex and manufacturing costs also increase due to an increase in the number of components.

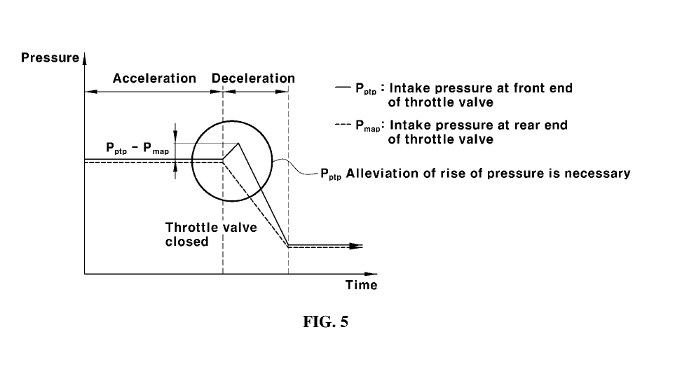

Referring to FIG. 5, when an accelerator pedal is released (e.g., disengaged) after an engine is accelerated as the accelerator pedal is engaged (e.g., pressure is exerted onto the pedal), the speed of the vehicle is reduced by an engine brake, and the supply of air into the engine is interrupted as a throttle valve is abruptly closed. Then, when the throttle valve is abruptly closed, air in an intake manifold disposed at a rear end of the throttle valve is not supplied into the engine anymore and is supercharged by a compressor of a turbocharger system, and accordingly, an intake pressure Pptp at a front end of the throttle valve and a pressure at an exit of the compressor of the turbocharger system may be temporarily abruptly increased to generate a surge state in a section indicated by a circle of FIG. 5, and the increased pressure applies an impact to the compressor via an intercooler and generate surge noise while forming pulse waves. Then, the intake pressure Pmap at the rear end of the throttle may be slowly reduced.

Accordingly, a phenomenon of applying an impact to the compressor as a surge is generated may be prevented and surge noise may be suppressed by alleviating an increase of an intake pressure Pptp at the front end of the throttle valve at a part indicated by a circle of FIG. 5. In particular, an apparatus and a method for controlling intake surge noise of an engine of a vehicle according to the present invention will be described in detail as an exemplary embodiment of the present invention.

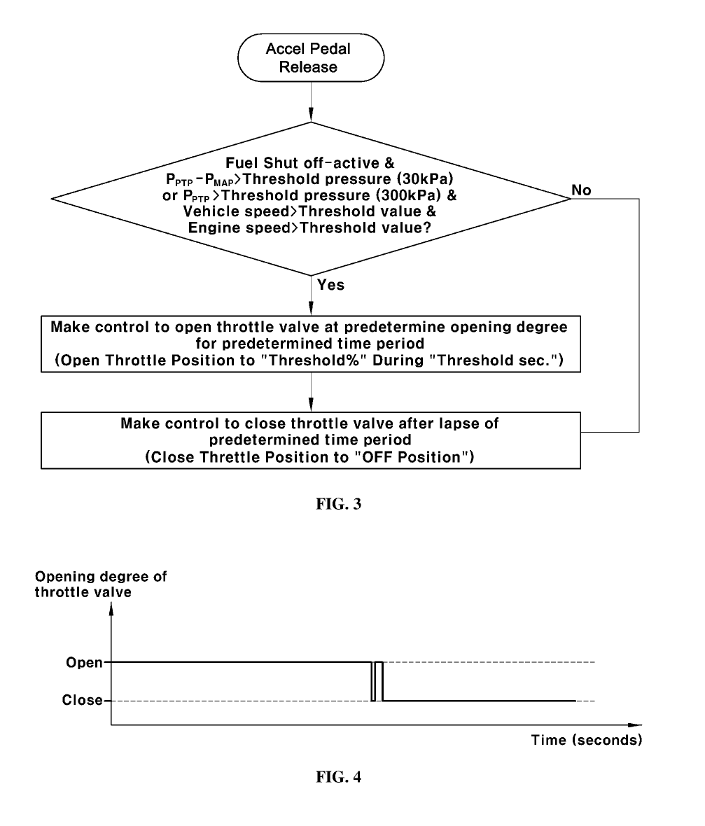

FIG. 2 is a diagram illustrating an apparatus for controlling intake surge noise of an engine of a vehicle according to the present invention. FIG. 3 is a flowchart illustrating a method for controlling intake surge noise of an engine of a vehicle according to the present invention. The methods described herein below may be executed by a controller having a processor and a memory. First, a closed state of a throttle valve may be detected while the vehicle is accelerated. In other words, while the vehicle is accelerated, a tip-out operation of releasing an accelerator pedal by the driver may be detected by an accelerator pedal engagement degree detection sensor configured to detect an engagement degree (e.g., the amount of pressure exerted onto the pedal) associated with a closed state of a throttle valve and a tip-out may be detected when dPₚₜₚ/dt is equal to or greater than a predetermined value, and then, the throttle valve may be automatically closed by the tip-out operation of the accelerator pedal.

As a result, the accelerator pedal engagement degree detection sensor 31 may be configured to detect a closing time point of the throttle valve, and transmit a detection signal to a controller 36. At the same time, a first pressure sensor 32 may be configured to detect an intake pressure at a front end of the throttle valve and transmit the detected intake pressure to the controller 36, a speed sensor 34 may be configured to detect a current vehicle speed and transmit the detected vehicle speed to the controller 36, and an engine revolutions per minute (RPM) sensor 35 may be configured to detect a current engine speed and transmit the detected engine speed to the controller 36. Subsequently, the controller 36 may be configured to determine that intake surge generation conditions are satisfied based on whether the throttle valve is closed, an intake pressure at a front end of the throttle valve, a speed of the vehicle, an engine speed, and the like. Notably, the various sensors described herein may be embodied as a single sensor that may be operated by the controller.

In particular, when the throttle valve is closed, a detection value of the first pressure sensor 32 may be a threshold pressure (e.g., about 300 kPa) or greater or a difference between values of the first pressure sensor and the second pressure sensor may be a threshold value or greater (e.g., about 30 kPa), and a vehicle speed and an engine speed may be threshold values or greater, the controller 36 may be configured to determine that conditions for generating an intake surge are satisfied, and then may be configured to interrupt a supply of a fuel into the engine and open the throttle valve at a predetermined degree for a predetermined time period (e.g., a time when the intake surge disappears).

Further, the threshold pressure may be a threshold value for an intake pressure that generates surge noise and influences the durability of the compressor while the throttle valve is closed, and may be calculated and determined by a noise, vibration and harshness (NVH) driving test and also may be determined using an actual driving test, considering that surge noise is generated at a predetermined vehicle speed and a predetermined engine speed. Accordingly, as illustrated in FIG. 4, as the throttle valve is opened at a predetermined degree (e.g., opening angle) for a predetermined time period after the throttle valve is closed, an increased surge pressure may be applied to the combustion chamber of the engine via an intake manifold at a rear end of the throttle valve through the opened throttle valve and as a result, surge noise due to the alleviation of the surge pressure may be suppressed even though an intake pressure Pptp at a front end of the throttle valve and a pressure at an exit of the compressor of the turbocharger system are temporarily increased.

Accordingly, after the throttle valve is opened at a predetermined degree for a predetermined time period, for alleviation of a surge pressure and suppression of surge noise, the throttle may be operated to be immediately closed after elapse of a predetermined time period to prepare for an accelerator pedal tip-in operation in which an acceleration intention of the driver is reflected and an opening operation of the throttle valve due to the tip-in operation. Meanwhile, a first pressure sensor 32 configured to detect an intake pressure in an intake manifold at a front end of the throttle valve and a second pressure sensor 33 configured to detect an intake pressure in an intake manifold at a rear end of the throttle valve may be used.

Particularly, since a pressure at the front end of the throttle valve may be increased and a pressure at the rear end of the throttle valve may be decreased causing a pressure difference between the front and rear ends of the throttle valve to be generated when the throttle valve is closed, the controller may be configured to determine that conditions for generation of an intake surge are satisfied when the throttle valve is closed, a difference between the values of the first pressure sensor and the second pressure sensor is a threshold value (e.g., about 30 kPa) or greater, and the vehicle speed and the engine speed are threshold values, and accordingly, the controller may be configured to interrupt a supply of a fuel into the engine and open the throttle valve at a predetermined degree for a predetermined time period, thereby simultaneously performing a surge pressure solving process and a noise suppressing process.

What is claimed is:

1. An apparatus for controlling intake surge noise of an engine of a vehicle, comprising:
an accelerator pedal engagement degree detection sensor configured to detect an engagement degree associated with a closed state of a throttle valve, while the vehicle is accelerated;
a first pressure sensor configured to detect an intake pressure at a front end of the throttle valve;
a speed sensor configured to detect a current vehicle speed;
an engine revolutions per minute (RPM) sensor configured to detect a current engine speed; and
a controller configured to interrupt a supply of a fuel into an engine and open the throttle valve at a predetermined degree for a predetermined time period simultaneously, when the throttle valve is closed, a detection value of the first pressure sensor is a threshold pressure or greater, and the vehicle speed and the engine speed are threshold values or greater.

2. The apparatus of claim 1, further comprising:
a second pressure sensor configured to detect an intake pressure in an intake manifold at a rear end of the throttle valve.

3. A method for controlling intake surge noise of an engine of a vehicle, comprising:
detecting, by a sensor, a closed state of a throttle valve while the vehicle is accelerated;
detecting, by the sensor, an intake pressure in an intake manifold at a front end of the throttle valve;
detecting, by the sensor, a current vehicle speed and an engine speed;
interrupting, by a controller, a supply of a fuel into an engine; and
opening, by the controller, the throttle valve at a predetermined degree for a predetermined time period simultaneously, when the throttle valve is closed, the intake pressure in the intake manifold at the front end of the throttle valve is a threshold pressure or greater, and the vehicle speed and the engine speed are threshold values or greater.

4. The method of claim 3, further comprising:
detecting, by the sensor, an intake pressure in an intake manifold at a rear end of the throttle valve.

5. The method of claim 3, further comprising:
closing, by the controller, the throttle valve after the throttle valve is opened at a predetermined degree for a predetermined time period.

6. The method of claim 3, wherein the threshold pressure is a threshold value for an intake pressure that generates surge noise and influences the durability of a compressor while the throttle valve is closed, and is a value measured using an actual vehicle driving test.

7. The method of claim 3, wherein the threshold speed is a value measured using an actual vehicle driving test, considering that surge noise is generated at a predetermined vehicle speed and a predetermined engine speed.

8. The method of claim 3, wherein the detection of a closed state of a throttle valve is applied in a tip-out situation in which the accelerator pedal is disengaged while the vehicle is accelerated.

9. A non-transitory computer readable medium containing program instructions executed by a controller, the computer readable medium comprising:
program instructions that control an accelerator pedal engagement degree detection sensor to detect an engagement degree associated with a closed state of a throttle valve, while a vehicle is accelerated;
program instructions that control a first pressure sensor to detect an intake pressure at a front end of the throttle valve;
program instructions that control a speed sensor to detect a current vehicle speed;
program instructions that control an engine revolutions per minute (RPM) sensor to detect a current engine speed; and
program instructions that interrupt a supply of a fuel into an engine and open the throttle valve at a predetermined degree for a predetermined time period simultaneously, when the throttle valve is closed, a detection value of the first pressure sensor is a threshold pressure or greater, and the vehicle speed and the engine speed are threshold values or greater.

10. The non-transitory computer readable medium of claim 9, further comprising:
program instructions that control a second pressure sensor to detect an intake pressure in an intake manifold at a rear end of the throttle valve.
